(19) United States
(12) Patent Application Publication
(10) Pub. No.: US 2007/0069629 A1
(43) Pub. Date: Mar. 29, 2007

(54) Flat type image display device and its manufacture method

(75) Inventors: Tetsu Ohishi, Hiratsuka (JP); Yoshie Kodera, Chigasaki (JP); Atsuo Ohsawa, Yokohama (JP); Akinori Maeda, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/512,581

(22) Filed: Aug. 29, 2006

(30) Foreign Application Priority Data
Sep. 27, 2005 (JP) 2005-280472

(51) Int. Cl. H01J 63/04

(52) U.S. Cl. 313/495; 445/24

(57) ABSTRACT

An image display device and its manufacture method are provided which are excellent in mass production at low cost and in reliability with a good quality of an assembled panel main body. In a thin type image display device having electrodes and an envelope accommodating components including the electrodes for displaying an image by electrons emitted from the electrodes, conductive adhesive of a low surface resistance is coated on the inner surface of the envelope or on the surfaces of the components accommodated in the envelope. The conductive adhesive has a surface resistance of 1×10¹⁰ Ω/□ or lower.

The present application claims priority from Japanese application JP 2005-280472 filed on Sep. 27, 2005, the content of which is hereby incorporated by reference into this application.

### BACKGROUND OF THE INVENTION

1. Field of the Invention

The present invention relates to a flat type image display device (hereinafter called a “field emission display” (FED)), and more particularly to a method of electrically connecting spacers to FED.

2. Description of the Related Art

Image display devices such as a cathode ray tube and a plasma display panel (PDP) are known which have a vacuum envelope requiring vacuum sealing and charge prevention and voltage breakdown prevention when voltage is applied.

Apart from liquid crystal display devices, self emission type flat panel displays are spreading widely and various types of flat panel structures have been proposed. In an FED, spacers such as thin plates are disposed in a vacuum sealed envelope in order to prevent breakage of the envelope by an atmospheric pressure against vacuum. Opposite ends of the spacer are fixed or electrically adhered to an anode and cathode. A high voltage is applied between the anode and cathode to accelerate electrons from the cathode. The high voltage is therefore applied also across the opposite ends of the spacer. A field emission (FE) type, a metal/insulator/metal (MIM) type and the like are known as cold cathode electron sources for emitting electrons.

Most of electrons emitted from the cathode abut on an anode phosphor to emit light. A portion of electrons abut on the anode is back-scattered and abuts on the spacer so that secondary electrons are emitted from the spacer leaving positive ions on the spacer and charging the spacer positive (+). As shown in FIG. 5, as the spacer is charged, an electric field is generated attracting electrons. As a result, as the spacer is charged, electrons emitted from the cathode are attracted by the electric field to transmit along an undesired trajectory 42 and predetermined optical emission at a desired phosphor 103 along a desired trajectory 41 will not be obtained or optical emission does not occur in some cases. As an image is displayed, a black stripe is formed around the spacer.

In order to avoid this, it is desired to leak charges on the spacer quickly (before the next display order) to the spacer to suppress the spacer charges as small as possible. Glass frit conductive adhesive made of glass frit mixed with conductive material such as Ag has been used conventionally. For example, Japanese Patent No. 3234188 (JP-A-10-334832) discloses that resistance is imparted to the surface of a spacer, the anode side of the spacer is fixed with glass frit adhesive and the cathode side is electrically abutted on a soft conductive member, using the adhesive on the cathode side forms a projected adhesive, the electric field is disturbed and a trajectory of electrons is curved. Japanese Patent No. 3129909 (JP-A-7-302540) discloses a spacer fixation structure by which opposite ends of a spacer are adhered with glass frit adhesive.

### SUMMARY OF THE INVENTION

In Japanese Patent No. 3234188 (JP-A-10-334832), since fixation between the spacer and cathode is performed by abutment (pressing), only the anode side of the spacer is fixed. As shown in FIGS. 6A and 6B, a height and width vary and a warp occurs. A height warp is about ±100 μm and a width warp is about ±200 μm. Fixation on only one side cannot correct a width warp of the spacer on the side not fixed. The spacer on the cathode side shifts from the electrode (width of about 200 μm). The shifted spacer obstructs emission of electrons from the cathode, posing a dark image problem. To overcome this, as described in the Patent No. 3129909 (JP-A-7-302540), a method is incorporated by which the cathode side is also fixed. However, if adhesive projects from the spacer width, an electric field is disturbed and the trajectory of electrons emitted from the cathode is influenced.

The main composition of adhesive, glass frit, melts before binder is cured, and covers conductive material Ag to form an insulating layer on the surface of the adhesive. Since the glass layer is an insulator and if the adhesive projects in the manner described above, the surface glass layer of the adhesive is charged, the electric field is disturbed and the trajectory of electrons is influenced. It can be considered that this phenomenon occurs frequently because Ag has a flake shape. The adhesive using glass frit lowers its viscosity until it is sintered, and sags. It is therefore difficult to coat thick adhesive (a height of 20 μm, for example) in a narrow width (200 μm, for example), posing a problem of protruded adhesive.

The present inventor has observed a display screen by inputting a signal to FED manufactured by the conventional techniques to display a whole white image. The observation result is shown in FIGS. 4A to 4C. Spacers 30 were conventionally fixed with glass frit conductive adhesives 114, 115 to a back substrate 1 and a display substrate 101 respectively. When displaying the whole white image, a black stripe image 105 (a state that phosphor does not emit light) was observed in the peripheral area of the position where the spacers 30 were fixed on the display substrate 101. And, a stripe black image 104 (a state that phosphor does not emit light) was also observed in the area where conventional glass frit conductive adhesives 114, 115 was coated between the spacers.

The conventional glass frit conductive adhesive has a high surface resistance. It can therefore be considered that the surface of the adhesive without the spacer is charged and the stripe black image appears. Since the surface resistance of the adhesive is high in the bonding area between the spacer and glass frit conductive adhesive, it can be considered that a sufficient electric conductivity is not obtained. The surface resistance of the conventional glass frit conductive adhesive was measured and was 1×10¹² Ω/□. The measurement was performed by pressing two electrodes to the surface of the conventional glass frit conductive adhesive, and the resistance was calculated from the voltage and current at the two electrodes. Since it is desired to smoothly flow current on the spacer, it is optimum that the proper value of the surface resistance is the same as the surface resistance of the spacer, and the value lower than that is preferable. Since the surface resistance of the spacer is 1×10⁶ to 1×10¹⁰ Ω/□, it can be considered that the surface resistance of glass frit conductive adhesive is required to be lower than 1 ×10⁶ to 1×10¹⁰ Ω/□. The measured surface resistance is higher than the above-described preferred value. It can therefore be considered that the portion coated with the conductive adhesive is charged and the stripe black image appears.

The reason why the surface resistance of the conventional glass frit is high may be ascribed to that binder in the glass frit burns during sintering and glass melts and covers the conductive material when it is solidified.

It can be considered that if conductive adhesive does not contain binder, the phenomenon of covering the conductive material will not occur and that the conductive material should be covered with carbon which is likely to form an irregular surface. It has been found that the surface resistance of adhesive after adhered and solidified is lower than the conventional resistance value. Carbon fine powders may burn in high temperature air. Also in this case, since the temperature can be set for silicon based adhesive lower than by 50 degrees than glass based adhesive, the silicon based adhesive is hard to be burnt. Furthermore, binder is not burnt as in the case of glass based adhesive, and the process can be executed in a vacuum atmosphere or in an atmosphere of incombustible gas such as N₂ so that carbon will not burn.

It can be considered from the foregoing description that the conventional problems can be solved by setting a surface resistance of the conductive adhesive used for FED to 1×10¹⁰ Ω/□ or lower, more preferably to 1×10⁶ Ω/□ or lower. It can also be considered that the conductive adhesive can be realized by mixing silicon based resin with carbon conductive material easy to form an irregular surface.

The present invention solves the above-described conventional problems and provides an image display device and its manufacture method which are excellent in mass production at low cost and in reliability with a good quality of an assembled panel main body.

The present invention provides a flat type image display device having electrodes including electron sources for emitting electrons, and an envelope accommodating components including the electrodes, for forming an image by electrons emitted from the electrode, wherein conductive adhesive of a low surface resistance is coated on an inner surface of the envelope or on the surfaces of the components accommodated in the envelope.

The conductive adhesive may have a surface resistance of 1×10¹⁰ Ω/□ or lower.

The conductive adhesive may be adhesive made of silicon based thermosetting resin mixed with carbon.

The conductive adhesive may be low temperature (300° C. or lower, preferably 200 to 300° C.) curing type adhesive.

The carbon may have a particle shape with projections.

The present invention provides a method of manufacturing an image display device including electrodes, a display substrate, a back substrate, a support frame and an envelope for accommodating components including the electrodes, the method comprising steps of: coating adhesive of silicon based thermosetting resin on a bonding portion or opposing portions of the display substrate, the back substrate, the support frame and the components accommodated in the envelope; and assembling the image display device and heating the image display device.

The components accommodated in the envelope may use silicon based thermosetting resin mixed with carbon.

The present invention provides an image display device and its manufacture method which are excellent in mass production at low cost and in reliability with a good quality of an assembled panel main body.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are schematic diagrams showing the mount structure of spacers in an image display device according to an embodiment, FIG. 1A is a side view and FIG. 1B is a top view.

FIGS. 2A and 2B are schematic diagrams showing spacers according to embodiments.

FIG. 3 is an illustrative diagram showing the relation between a resistance and an optical emission position shift according to an embodiment.

FIGS. 4A, 4B and 4C are schematic diagrams showing the mount structure explaining influence of charges on adhesive used by a conventional image display device, FIG. 4A is a plan view, FIG. 4B is a horizontal cross sectional view and FIG. 4C is a vertical cross sectional view.

FIGS. 5A and 5B are schematic diagrams illustrating the influence upon electrons in a conventional image display device, FIG. 5A is a side view and FIG. 5B is a top view.

FIGS. 6A and 6B are schematic diagrams illustrating warps of a spacer in a conventional image display device, FIG. 6A is a side view and FIG. 6B is a top view.

### DESCRIPTION OF THE EMBODIMENTS

Preferred embodiments of the present invention will be described.

With reference to the accompanying drawings, description will be made on a flat type image display device and its manufacture method.

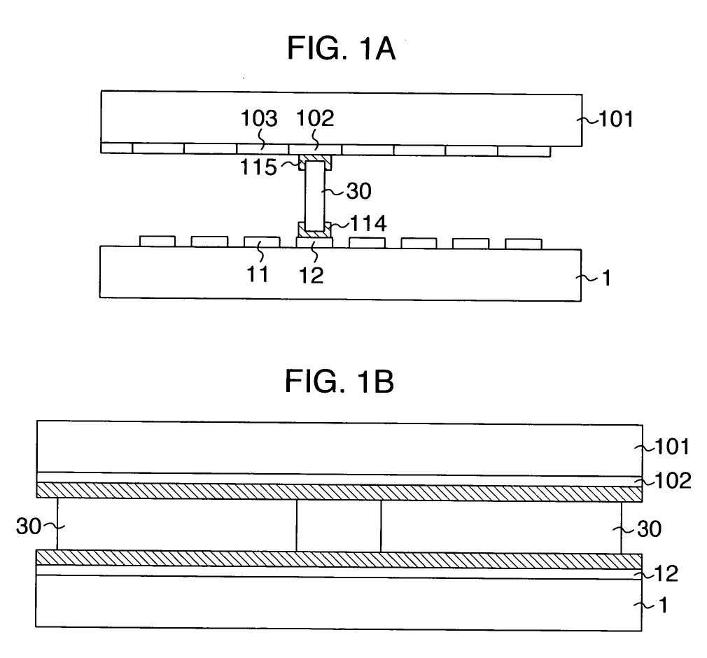

FIG. 1 is a schematic diagram showing the mount structure of spacers disposed between a back substrate and a display substrate of an image display device according to an embodiment of the invention, FIG. 1A is a side view and FIG. 1B is a top view. In FIGS. 1A and 1B, a plurality of spacers 30 of e.g., a flat plate shape, are disposed in parallel along an elongated direction in such a manner that one end of each spacer is connected to a metal bask 102 of a display substrate 101 with conductive adhesive 115 and the other end is connected to a scan line 12 of a back substrate 1 with conductive adhesive 114.

In order not to obstruct a trajectory of electrons travelling from an electrode 11 as an electron source to a phosphor 103, the spacers of the flat plate shape are disposed in such a manner that on the display substrate 101 side, the spacer is disposed on the metal back 102 of a black optical absorption layer, e.g., a black matrix disposed between R, G and B phosphors constituting pixels in order to improve a contrast, and that on the back substrate 1 side, the spacer is disposed on, for example, a cathode drive electrode line 11 or on a metal film formed on a surface protective film of the electrode line.

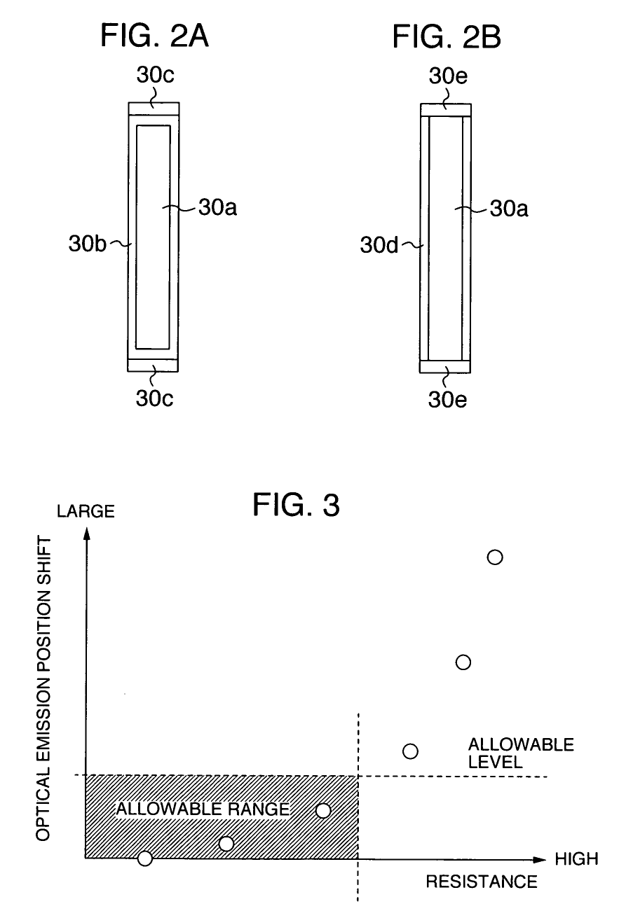

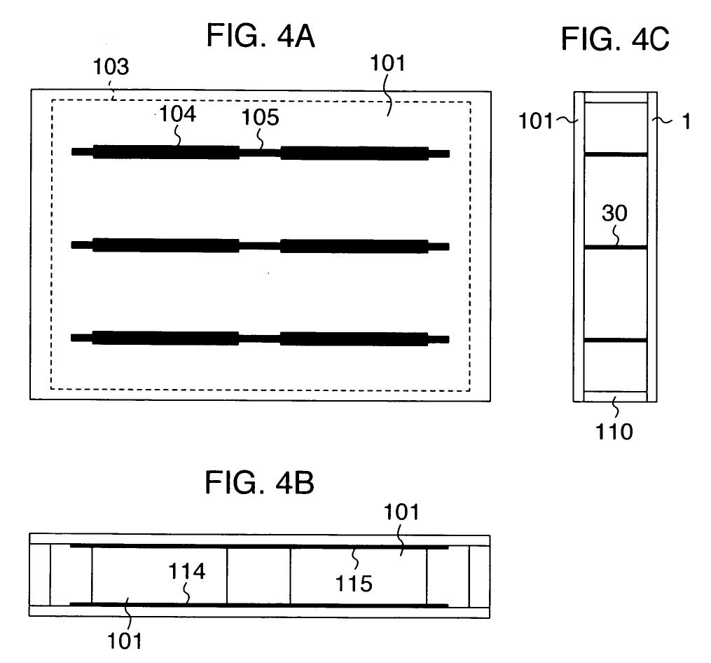

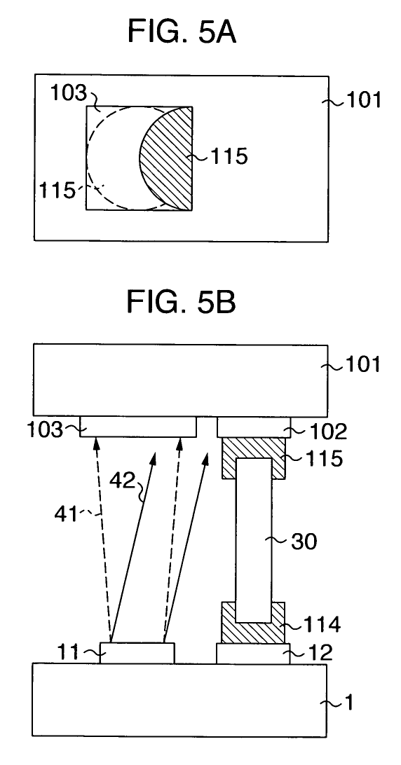

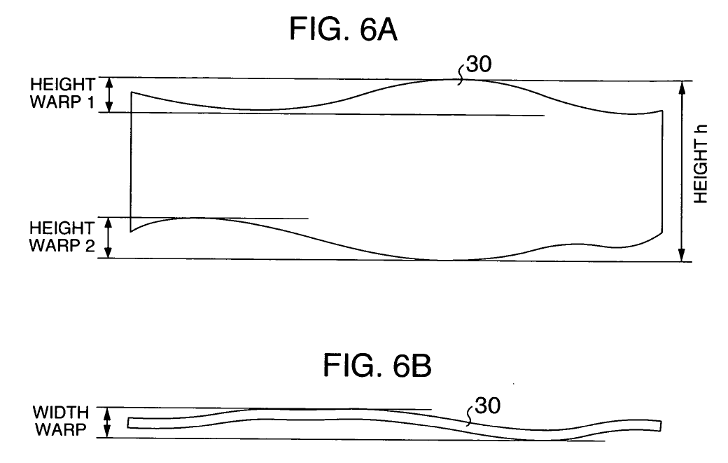

The spacer 30 is charged by electrons emitted from an electron emitting element. Therefore, the trajectory of electrons from the electron emitting element is curved near the spacer and an image distortion phenomenon occurs. In order to prevent this, as shown in FIGS. 2A and 2B, charge preventive conductive films 30b and 30d are formed on the surfaces of spacers 30a to flow small current on the surfaces of the spacers 30a. The conductive film is made of a high resistance film such as a thin film of tin oxide and a mixed crystal thin film of tin oxide and indium oxide, or a metal film. To make current flow easily, the spacer 30 is electrically connected between the metal back 102 and the metal film between upper electrode lines, with conductive adhesive. In order to increase conductivity, metal electrodes 30c and 30e of Cr or the like may be formed on the ends of the spacers 30a. It is necessary to have conductivity between the charge preventive conductive film and the metal electrode. Although the charge preventive film is formed on the surface of the spacer, the embodiment is not limited thereto because charges can be avoided by providing the spacer itself with conductivity.

Anode voltage (e.g., 5 to 15 KV) applied to the metal back is applied to the metal film on the back substrate via the spacer. The scan line is connected to a ground potential via a scan circuit (not shown), and current from the anode electrode at a high voltage flows into the ground potential. If a volume resistivity is small, leak current at a high voltage is large and an efficiency lowers, whereas if the volume resistivity is too large, current becomes too small. It is therefore preferable to set the volume resistivity in a range of 1×10⁶ to 1×10¹² Ω/□.

The conductive adhesive 114 is, for example, silicon based adhesive mixed with fine carbons (carbon nanotubes, micro carbon powders and the like). The adhesive may be adhesive of silicon resin containing phenylheptamethylcyclotetrasiloxane and 2, 6-1 cis-diphnylhexamethylcyclotetrasiloxane, as described for example in JP-A-2004-182959. In this embodiment, the conductive adhesive 114 is coated on a spacer bonding portion of the display substrate 1, through printing or with a dispenser, and cured at 200° C. to 300° C. to fix the spacer. The conductive adhesive 114 used in this embodiment may not be the above-described silicon based adhesive and is not limited thereto, but any other materials may be used so long as the materials are low temperature curing adhesive having the characteristics of curing at a low temperature (300° C. or lower, or preferably 200° C. to 300° C.) A viscosity is adjusted during a coating process by using silicon resin as described in JP-A-2004-182959. If the surface of each carbon particle is irregular, the resistance lowers. A desired resistance value can be set easily from preliminary tests, although the resistance changes with a mixture ratio of carbon, a carbon particle diameter and a carbon shape.

An allowable resistance range of the adhesive can be obtained by measuring beforehand the relation between an adhesive resistance value and an emission position shift after assembly of a flat type display device, as shown in FIG. 3. According to experiments, the resistance of the adhesive is required to be smaller than that of the spacer, and current will flow through the spacer if the resistance of the adhesive is lower than that of the spacer by two digits or more.

Particular numerical values will be given. A volume resistance was 700 Ω·cm and a surface resistance was 100 kΩ/□, under the conditions that a carbon particle diameter was 5 μm in average and had an ellipsoidal sphere having an irregular surface and that carbon was mixed with silicon based adhesive at a weight ratio of 5%. Although these values are required to be lower than the spacer resistance, current will flow through the spacer sufficiently if the resistance of the carbon is lower by two digits or more.

The resistance value can be controlled in the range from about 10 kΩ·cm to several Ω·cm if a weight ratio of carbon to silicon based adhesive is 1% to 50%. This resistance value range is sufficient for spacer bonding usage.

The display substrate 101 and back substrate 1 with the fixed spacers are assembled by using a support frame 110 and the inside is set to a vacuum sealed state of about 10⁻⁵ to 10⁻⁷ Torr to complete the flat type display device.

In the flat type display device constructed as above, the conductive adhesive made of silicon based adhesive mixed with carbon is free of a large viscosity reduction during curing because the adhesive is thermosetting. Therefore, mixed carbon is less covered with the silicon resin at the surface of the adhesive so that the surface resistance can be lowered. Therefore, conductivity can be ensured at the same time when the spacers are fixed and the lowered surface resistance can be obtained. It is therefore possible to realize spacer fixation, spacer current retention and charge prevention of the bonding portion. A spacer fixation structure can be realized which hardly influences the trajectory of electrons emitted from the cathode. The conductive adhesive can be used also for the components accommodated in the envelope, in addition to the spacer.

The conductive adhesive made of silicon based adhesive mixed with carbon is thermosetting and the viscosity of the silicon resin is properly adjusted. Therefore, the adhesive can be cured by maintaining almost the same shape as that at the time when the adhesive layer is formed through preheating, so that a good thixotropic nature can be obtained. It is therefore possible to suppress projection of the adhesive when the spacer is fixed, and to suppress projection of the adhesive from the spacer fixing wiring. A spacer fixation structure can be realized which hardly influences the trajectory of electrons emitted from the cathode.

In this embodiment, fine carbons (carbon nanotubes, micro carbon powders, and the like) are mixed in the above-described silicon based adhesive. The viscosity is adjusted by using silicon resin, as described in JP-A-2004-182959. The resistance lowers as carbon has an irregular surface.

The spacer is fixed by using the adhesive. The frame glass may also be fixed by using similar adhesive. In this case, the process becomes easy. The surface resistance of the adhesive is set the same as or lower than that of the spacer.

The adhesive is used for the cathode side at the position near the cathode emission portion with a relatively slow electron speed and at a low voltage providing a large secondary electron emission coefficient. Adhesive different from the embodiment adhesive may be used for the anode side. It is convenient if adhesion between the spacer and cathode and between the anode and support frame is performed at the same time. Therefore, in order to use the same heating temperature, it is preferable to use silicon based adhesive for adhesion between the anode and support frame.

Since it is not necessary to burn binder, an oxygen atmosphere is not necessary and fixation can be performed at a lower temperature (as compared to glass frit adhesive), so that there is no deterioration of the cathode.

Since a cathode exposure environment can be realized by vacuum or a gas atmosphere not contaminating the cathode, undesired gas will not be absorbed in the cathode and cathode contamination can be prevented.

Since there is a good thixotropic nature and the adhesive layer can be made thick, a height precision of the spacer is not required to be strict. It is therefore unnecessary to manufacture the spacer at a height precision of about ±10 μm, and a high cost work such as polishing is not necessary, resulting in a low cost of the spacer. The spacer can be manufactured easily at low cost. It is preferable for glass frit to set a coating width and coating height to 200 μm and 20 μm, respectively.

As disclosed in JP-A-2004-182959, adhesion is possible without strictly setting the value of a, inexpensive material (e.g., alumina) may be used depending upon usage, e.g., a large number of spacers to resist against an atmospheric pressure. If a small number of spacers are to be used, high strength material (e.g., zirconia) may be used.

Since a process temperature is low, a power consumption amount is small realizing a process not contaminating the environment, and inexpensive jigs can be formed easily. Since zinc is not used, a device not contaminating the environment can be realized. Since charges curving an electron trajectory can be avoided, a uniform image can be obtained without non-emission areas near spacers.

It should be further understood by those skilled in the art that although the foregoing description has been made on embodiments of the invention, the invention is not limited thereto and various changes and modifications may be made without departing from the spirit of the invention and the scope of the appended claims.

1. An image display device comprising:
electrodes including electron sources for emitting electrons; and
an envelope accommodating components including said electrodes,
wherein said envelope has a display substrate disposed on an image display side for forming an image by electrons emitted from said electrodes, and conductive adhesive of a low surface resistance is coated on an inner surface of said envelope or on surfaces of said components accommodated in said envelope.

2. The image display device according to claim 1, wherein said conductive adhesive has a surface resistance of 1×10¹⁰ Ω/□ or lower.

3. The image display device according to claim 1, wherein said conductive adhesive is adhesive containing silicon based thermosetting resin mixed with carbon.

4. The image display device according to claim 3, wherein said carbon has a particle shape with projections.

5. The image display device according to claim 1, wherein said conductive adhesive is low temperature curing type adhesive.

6. The image display device according to claim 5, wherein said low temperature curing type adhesive has characteristics of curing at 300° C. or lower.

7. The image display device according to claim 5, wherein said low temperature curing type adhesive has characteristics of curing at 200° C. to 300° C.

8. An image display device comprising:
electrodes including electron sources for emitting electrons; and
an envelope accommodating components including said electrodes,
wherein said envelope has a display substrate disposed on an image display side for forming an image by electrons emitted from said electrodes, and conductive adhesive of a low temperature curing type is coated on an inner surface of said envelope or on a surface of said components accommodated in said envelope.

9. The image display device according to claim 8, wherein said low temperature curing type adhesive has characteristics of curing at 300° C. or lower.

10. The image display device according to claim 8, wherein said low temperature curing type adhesive has characteristics of curing at 200° C. to 300° C.

11. A method of manufacturing an image display device including electrodes, a display substrate, a back substrate, a support frame and an envelope for accommodating components including said electrodes, the method comprising steps of:
coating adhesive of silicon based thermosetting resin on a bonding portion or opposing portions of said display substrate, said back substrate, said support frame and said components accommodated in said envelope; and
assembling the image display device and heating the image display device.

12. The method of manufacturing an image display device according to claim 11, wherein said components accommodated in said envelope include silicon based thermosetting resin mixed with carbon.
